(19) United States
(12) Patent Application Publication
(10) Pub. No.: US 2022/0339652 A1
(43) Pub. Date: Oct. 27, 2022

(54) BOTTLE FOR PUMPABLE FLUIDS

(71) Applicants: Warren Willard Tryon, Briarcliff Manor, NY (US); Elizabeth Tryon, Briarcliff Manor, NY (US)

(72) Inventors: Warren Willard Tryon, Briarcliff Manor, NY (US); Elizabeth Tryon, Briarcliff Manor, NY (US)

(21) Appl. No.: 17/659,917

(22) Filed: Apr. 20, 2022

Related U.S. Application Data
(60) Provisional application No. 63/178,329, filed on Apr. 22, 2021.

(51) Int. Cl. B05B 11/00

(52) U.S. Cl. CPC B05B 11/3042

(57) ABSTRACT

A pump bottle includes a pumping mechanism at a top of the bottle, a neck, a stabilizing vertical sidewall extending from the neck, a collector joined to the stabilizing vertical sidewall, forming an intersection, where the collector is sloped from the intersection, converging to a nadir centered beneath the neck, and the stabilizing vertical sidewall supporting the bottle when in an upright position and forming an open recess underneath the collector.

### CROSS-REFERENCE TO RELATED APPLICATION

This application claims the benefit of priority of U.S. provisional application No. 63/178,329, filed Apr. 22, 2021, the contents of which are herein incorporated by reference.

### BACKGROUND OF THE INVENTION

The present invention relates to bottles and, more particularly, to bottles for pumpable fluids.

Ordinary pump bottles often pump out air along with the product, especially when product becomes low. With ordinary pump bottles, the consumer experiences useless air pumps and little or no product comes out after multiple pumps or only a little product shoots out under pressure. Ordinary pump bottles never pump out all of their contents, resulting in product waste and less consumer value. Product is then left on the bottom and on the sides, inside of the bottle. The consumer is never able to access all of the bottle's product, unless the consumer unscrews and removes the pump entirely, shakes and hits the bottle, or turns the bottle upside down and enlists gravity to slowly drain the contents out. Consumers who discard pump bottles with residual content add to the waste stream. Existing ordinary pump bottles have no way of efficiently minimizing product waste and further minimizing wasted pumps.

Ordinary pump bottles cannot pump out all of their product. As they get closer to empty, the pumps no longer smoothly pump out product. Once product is no longer directly beneath a pump tube, the tube cannot extract that product. Thus, ordinary bottles pump a mixture of product and air, and often only air, when product becomes low. Then they stop pumping product while residual product still remains inside of the bottle as the product sticks to a side, front, or back of the bottle interior.

Some bottles have been developed to funnel product to the bottom of the bottle, underneath the pump tube. However, these bottles require extra material, often plastic, to develop. This additional plastic often costs more than the product it is intended to save. In addition, this excess plastic further strains Earth's limited non-renewable resources and often ends up in a landfill.

As can be seen, there is a need for a pump bottle that enables a user to capture all of the product within the bottle while limiting the amount of extra materials used to form the product.

### SUMMARY OF THE INVENTION

In one aspect of the present invention, a pump bottle comprises a pumping mechanism at a top of the bottle, a neck, a stabilizing vertical sidewall extending from the neck, a collector joined to the stabilizing vertical sidewall, forming an intersection, wherein the collector is sloped from the intersection, converging to a nadir centered beneath the neck, and the stabilizing vertical sidewall supporting the bottle when in an upright position and forming an open recess underneath the collector.

In another aspect of the present invention, a pump bottle comprises a body having a neck and sidewalls, a collector joined to the body, a sealed bottom of the collector positioned directly underneath the neck when the pump bottle is standing upright, the sidewalls supporting the pump bottle in an upright position, and a lower surface of the collector exposed by an open recess at a base of the body.

In another aspect of the present invention, a pump bottle comprises, a pumping mechanism at a top of the bottle, a neck, a stabilizing vertical sidewall extending from the neck, and a recessed bottom that is operative to continuously collecting product directly underneath a pump tube fastened to the neck.

These and other features, aspects and advantages of the present invention will become better understood with reference to the following drawings, description, and claims.

### BRIEF DESCRIPTION OF THE DRAWINGS

FIG. 1 is a perspective view of a round container pump bottle in an upright position according to an embodiment of the present invention;

FIG. 2 is a perspective view thereof, shown without a pump top;

FIG. 3 is a bottom perspective view thereof;

FIG. 4 is a section view taken on line 4-4 of FIG. 2;

FIG. 5 is a perspective view of a rectangular container pump bottle in an upright position according to an embodiment of the present invention;

FIG. 6 is a bottom perspective view thereof; and

FIG. 7 is a section view taken on line 7-7 of FIG. 5.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims with reference to the drawings.

A general overview of the various features of the invention will be provided, with a detailed description following. Broadly, an embodiment of the present invention may provide a bottle with a body and a collector, utilizing gravity to collect a product underneath a pump tube until substantially all of the product has been pumped out with a pump handle or a pumping mechanism. The collector may be conical or substantially conical or may resemble an inverted pyramid including a triangular pyramid, square pyramid, rectangular pyramid, pentagonal pyramid, or a similar structure. The collector may be funnel-like and V-shaped. The collector may be sloped with a bottom point near a center of the collector and a top point at an intersection of the collector and side walls of the bottle. The collector may be sloped and converge to a nadir centered beneath the beck. The nadir of the collector may be a planar surface or a curved surface. The nadir may support the pump bottle when in an upright position.

A shape of the collector, such as a pyramid, may simplify a production process, serve an aesthetic purpose, and functionally gather product in the bottle.

In some embodiments of the present invention, a shape of the bottle may be modified to include the collector. Alternatively, a collector may be inserted into the pump bottle, underneath the pump tube. The collector may also be unitary with the pump bottle and molded as one unit. The collector may be incorporated into the shape of the bottle, such as molded with the bottle, or added as an insert near the bottom of the bottle. A collector may be inserted into the bottle, near the bottom of the bottle. Alternatively, the collector may be molded into or as part of the bottle.

The collector may be positioned inside of the bottle in such a way that a lowest point of the collector is centered under the pump tube. The pump handle may be at a top of the tube, as with prior art.

The collector may enable gravity to continuously urge the product in the bottle directly under the pump tube. When a pump handle is activated, product is sucked up the pump tube and expelled out of the bottle, as it does in prior art. In the present invention, gravity causes product in the bottle to collect at a low point underneath the pump tube on the collector. The low point may be a sealed bottom. Gravity funnels or collects product on the collector where it lays beneath the pump tube, enabling smooth, even pumps and extracting a maximum amount of product from the bottle.

In some embodiments of the present invention, the bottle may have an open base comprising stabilizing vertical sidewalls extending down from a top of the collector. An open recess may exist underneath the collector, exposing a lower surface of the collector to a supporting surface, such as a counter or the floor. Side walls of the bottle may extend towards the floor.

The sidewalls of the bottle may make contact with the floor or a ground when the bottle is standing upright. A center of the collector may also make contact with the ground when the bottle is standing upright. This enables the bottle to stand upright without a horizontal base, thus using less material, such as plastic, in its formation. An intersection of the walls and the collector may be reinforced, such as with extra plastic.

The pump bottle may include vertical stabilizing walls extending from the beck of the bottle. The collector may be a recessed bottom, operative to continuously collecting product directly underneath the pump tube. The pump tube may be fastened to the neck of the bottle. The recessed bottom may be configured to the bottle near a bottom end of the bottle or the bottom most point of the vertical stabilizing walls. In some embodiments of the present invention, the bottle may be six-eight inches tall. In some embodiments of the present invention, the recessed bottom may join the vertical stabilizing wall one-three inches above a bottom most point of the vertical stabilizing wall.

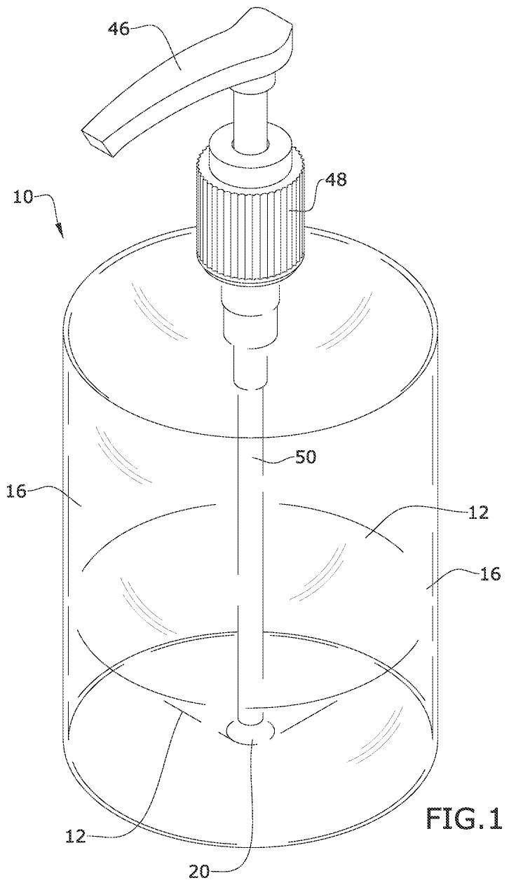

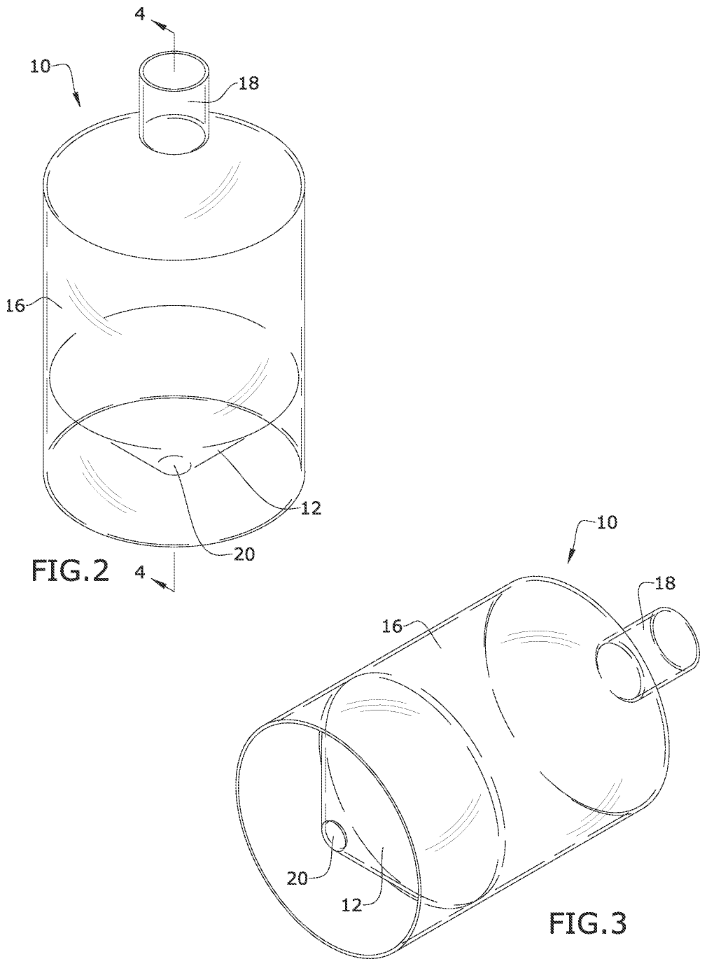

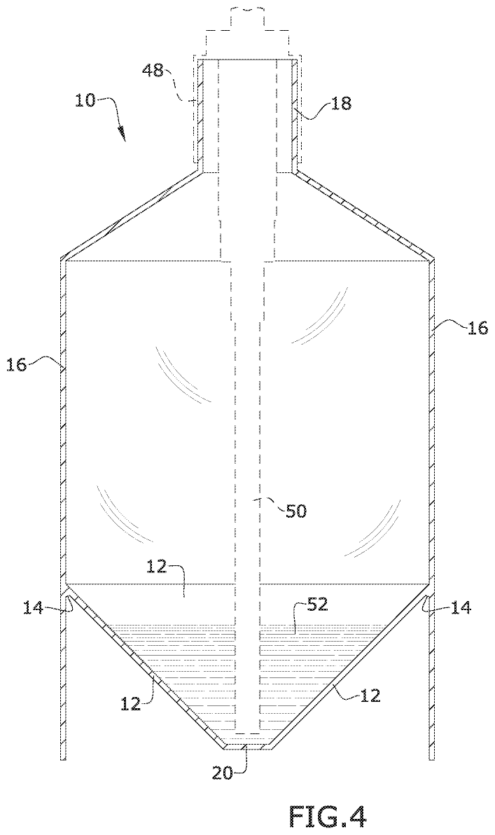

Referring now to the Figures, FIGS. 1 through 4 illustrate a cylindrical container 10 according to an embodiment of the present invention. A collector 12 is housed within or formed into the cylindrical container 10. The collector 12 is conical with a sealed and flat bottom 20. Product 52 collects via gravity within the cylindrical container 10 on the bottom 20. The bottom 20 is centered beneath a pump tube 50. The pump tube 50 is fluidly connected to a pump cap 48 and pump handle 46. The pump cap 48 attaches to a container neck 18. As best seen in FIG. 4, cylindrical container walls 16 extend to a floor enabling the cylindrical container 10 to stand upright. A reinforced join 14 is formed at an intersection of the cylindrical container walls 16 and the collector 12.

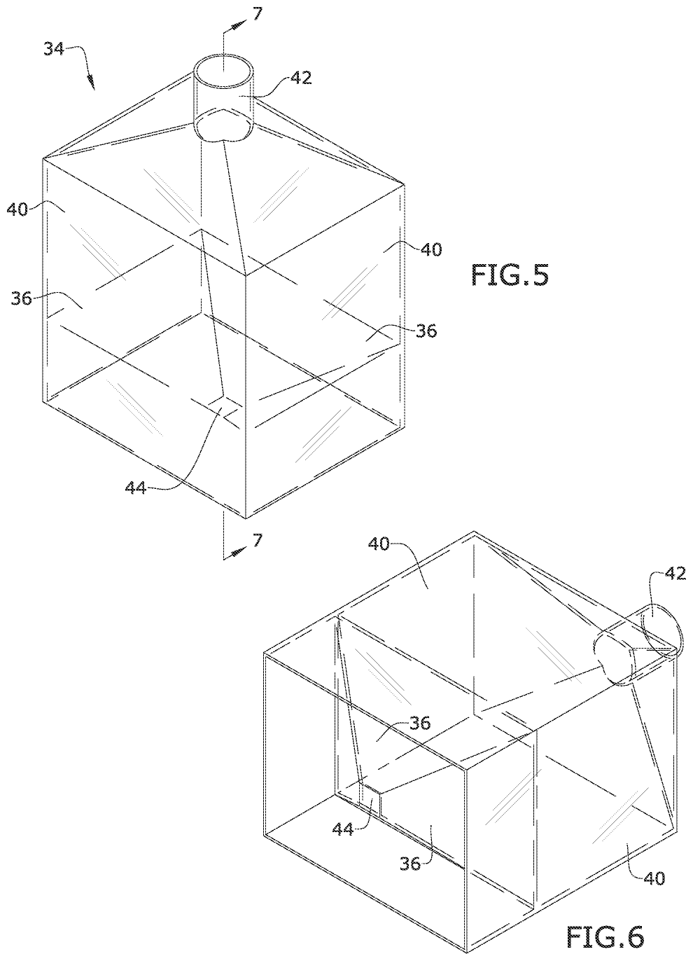

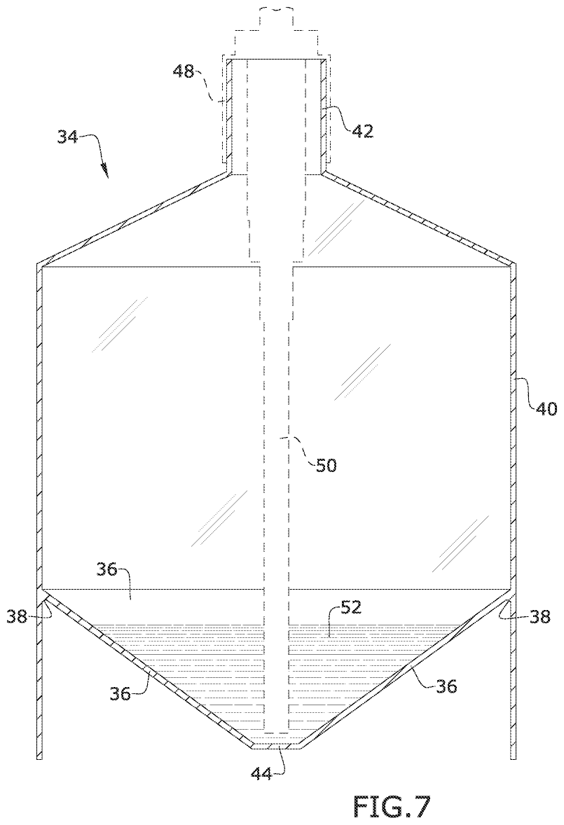

FIGS. 5 through 7 depict a rectangular container 34 according to another embodiment of the present invention comprising an inverted rectangular pyramidal collector 36 is housed within the rectangular container 34. The inverted rectangular pyramidal collector 36 collects the product 52 at a rectangular bottom 44. The rectangular bottom 44 is centered beneath the pump tube 50. The pump tube 50 is connected to a pump cap 48 which fluidly connects to a second embodiment of a container neck 42. As best seen in FIG. 7, rectangular container walls 40 extend vertically to the floor, enabling the rectangular container 34 to stand upright. Rectangular container reinforced joins 38 are formed at intersections of the rectangular container walls 40 and the inverted rectangular pyramidal collector 36.

It should be understood, of course, that the foregoing relates to exemplary embodiments of the invention and that modifications may be made without departing from the spirit and scope of the invention as set forth in the following claims.

What is claimed is:

1. A pump bottle comprising:
a pumping mechanism at a top of the bottle;
a neck;
a stabilizing vertical sidewall extending from the neck;
a collector joined to the stabilizing vertical sidewall, forming an intersection, wherein the collector is sloped from the intersection, converging to a nadir centered beneath the neck; and
the stabilizing vertical sidewall supporting the bottle when in an upright position, forming an open recess underneath the collector.

2. The pump bottle of claim 1, wherein the intersection of the collector and the stabilizing vertical sidewall is reinforced.

3. The pump bottle of claim 1, wherein a reinforced join is formed at the intersection of the collector and the stabilizing vertical sidewall.

4. The pump bottle of claim 1, wherein the nadir of the collector is a planar surface that supports the pump bottle when in an upright position.

5. The pump bottle of claim 1, wherein the nadir of the collector is a curved surface that supports the pump bottle when in an upright position.

6. The pump bottle of claim 1, wherein the collector is conical.

7. The pump bottle of claim 1, wherein the collector is an inverted pyramid.

8. A pump bottle comprising:
a body having a neck and sidewalls;
a collector joined to the body;
a sealed bottom of the collector positioned directly underneath the neck when the pump bottle is standing upright;
the sidewalls supporting the pump bottle in an upright position; and
a lower surface of the collector exposed by an open recess at a base of the body.

9. The pump bottle of claim 8, wherein an intersection of the collector and the sidewalls is reinforced.

10. The pump bottle of claim 8, wherein a reinforced join is formed at an intersection of the collector and the sidewall.

11. The pump bottle of claim 8, wherein a bottom of the collector supports the pump bottle when in an upright position.

12. The pump bottle of claim 8, wherein a bottom of the collector is a planar surface that supports the pump bottle when in an upright position.

13. The pump bottle of claim 8, wherein the bottom of the collector is a curved surface that supports the pump bottle when in an upright position.

14. The pump bottle of claim 8, wherein the collector is conical.

15. The pump bottle of claim 8, wherein the collector is an inverted pyramid.

16. The pump bottle of claim 8, wherein the collector is unitary with the pump bottle.

17. A pump bottle comprising:
a pumping mechanism at a top of the bottle;
a neck;
a stabilizing vertical sidewall extending from the neck; and
a recessed bottom that is operative to continuously collecting product directly underneath a pump tube fastened to the neck.

18. The pump bottle of claim 17, wherein an intersection of the recessed bottom and the stabilizing vertical sidewall is reinforced.

19. The pump bottle of claim 17, wherein the recessed bottom is a curved surface that supports the pump bottle when in an upright position.

20. The pump bottle of claim 17, wherein the recessed bottom is an inverted pyramid.
